(19) United States
(12) Patent Application Publication
(10) Pub. No.: US 2019/0043442 A1
(43) Pub. Date: Feb. 7, 2019

(54) IMAGE METADATA OVER EMBEDDED DATAPORT

(71) Applicant: Intel Corporation, Santa Clara, CA (US)

(72) Inventors: Sameer KP, Bangalore (IN); Vinay Angadi, Bellandur (IN); Yiting Lee, Taipei (TW); Roland Wooster, Folsom, CA (US); Sagar Karalatti, Bellandur (IN)

(73) Assignee: Intel Corporation, Santa Clara, CA (US)

(21) Appl. No.: 16/034,302

(22) Filed: Jul. 12, 2018

(51) Int. Cl. G09G 5/00; G09G 5/04; G09G 3/34; G06F 17/30

(52) U.S. Cl. CPC G09G 5/006; G09G 5/04; G09G 2360/16; G06F 17/3025; G09G 2320/0233; G09G 3/3413

(57) ABSTRACT

A processing unit, device, system and method are described. A processing unit can be configured to access frame data and associated metadata. The processing unit can be configured to send the associated metadata from a processing unit to a display controller on a channel that is different than a channel configured to send the frame data.

### BACKGROUND

Computer processors and associated graphic processing units include digital display interfaces that enable them to transmit visual data to a display device for presentation. The Video Electronics Standards Association (VESA) develops standards that are used to create standardized digital display interfaces that can be implemented in many different devices. Devices that implement these standards typically continue to be produced for many years after the standard has been created. During the relevant lifespan of a specific standard, other aspects of technology often evolve. As a result, either the digital display interface standard or particular implementations of the standard are unable to accommodate new features or improvements.

The embedded display port interface standard (eDP) defines a standardized display panel interface for internal connections (e.g., graphics cards to notebook display panels, etc.). However, due to the afore-mentioned timing issue, recent updates in display technology have been unavailable for at least some implementations of the eDP standard. For example, innovations in high dynamic range (HDR) display technology have not been fully integrated into all implementations of the eDP standard. This inability is the result of the fact that in some cases HDR display technology employs metadata about one or more images to correctly display the HDR content. Some eDP devices are unable to transfer this metadata through the main channel of the digital display interface due to limits in the circuitry that implements the eDP standard.

### BRIEF DESCRIPTION OF THE DRAWINGS

Features and advantages of example embodiments will be apparent from the detailed description which follows, taken in conjunction with the accompanying drawings, which together illustrate, by way of example, features; and, wherein:

FIG. 1 illustrates a processing unit in accordance with an example embodiment.

FIG. 2 illustrates an example electronic device in accordance with an example embodiment.

FIG. 3 illustrates a computer system in accordance with an example embodiment.

FIG. 4 shows a block diagram illustrating a method for enabling a high dynamic range capable display in accordance with some example embodiments.

FIG. 5 is a flow diagram for a method of providing HDR metadata over an eDP interface in accordance with some example embodiments.

FIG. 6 depicts an exemplary system upon which embodiments of the present disclosure may be implemented.

Reference will now be made to the exemplary embodiments illustrated, and specific language will be used herein to describe the same. It will nevertheless be understood that no limitation on scope is thereby intended.

### DESCRIPTION OF EMBODIMENTS

Before technology embodiments are described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for describing particular examples or embodiments only and is not intended to be limiting. The same reference numerals in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, network examples, etc., to convey a thorough understanding of various technology embodiments. One skilled in the relevant art will recognize, however, that such detailed embodiments do not limit the overall technological concepts articulated herein, but are merely representative thereof.

As used in this written description, the singular forms “a,” “an” and “the” include express support for plural referents unless the context clearly dictates otherwise. Thus, for example, reference to “an” engine includes a plurality of such engines.

Reference throughout this specification to “an example” means that a particular feature, structure, or characteristic described in connection with the example is included in at least one technology embodiment. Thus, appearances of the phrases “in an example” or “in an embodiment” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and examples can be referred to herein along with alternatives for the various components thereof. It is understood that such embodiments, examples, and alternatives are not to be construed as de facto equivalents of one another, but are to be considered as separate and autonomous representations under the present disclosure.

Furthermore, the described features, structures, or characteristics can be combined in any suitable manner in one or more embodiments. In the following description, numerous specific details are provided, such as examples of layouts, distances, network examples, etc., to provide a thorough understanding of embodiments of the disclosed technology. One skilled in the relevant art will recognize, however, that the technology can be practiced without one or more of the specific details, or with other methods, components, layouts, etc. In other instances, well-known structures, materials, or operations may not be shown or described in detail to avoid obscuring aspects of the disclosure.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open-ended term in this written description, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, comparative terms such as “increased,” “decreased,” “better,” “worse,” “higher,” “lower,” “enhanced,” “minimized,” “maximized,” “increased,” “reduced,” and the like refer to a property of a device, component, function, or activity that is measurably different from other devices, components, or activities in a surrounding or adjacent area, in a single device or in multiple comparable devices, in a group or class, in multiple groups or classes, related or similar processes or functions, or as compared to the known state of the art. For example, a data region that has an “increased” risk of corruption can refer to a region of a memory device, which is more likely to have write errors to it than other regions in the same memory device. A number of factors can cause such increased risk, including location, fabrication process, number of program pulses applied to the region, etc.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases, depend on the specific context. However, generally speaking, the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

The term “coupled,” as used herein, is defined as directly or indirectly connected in an electrical or nonelectrical manner. “Directly coupled” items or objects are in physical contact and attached to one another. Objects or elements described herein as being “adjacent to” each other may be in physical contact with each other, in close proximity to each other, or in the same general region or area as each other, as appropriate for the context in which the phrase is used.

Numerical amounts and data may be expressed or presented herein in a range format. It is to be understood, that such a range format is used merely for convenience and brevity, and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

As used herein, the term “circuitry” can refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some aspects, the circuitry can be implemented in, or functions associated with the circuitry can be implemented by, one or more software or firmware modules. In some aspects, circuitry can include logic, at least partially operable in hardware.

Various techniques, or certain aspects or portions thereof, may take the form of program code (i.e., instructions) embodied in tangible media, such as floppy diskettes, compact disc-read-only memory (CD-ROMs), hard drives, transitory or non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a random-access memory (RAM), erasable programmable read only memory (EPROM), flash drive, optical drive, magnetic hard drive, solid state drive, or other medium for storing electronic data. The node and wireless device may also include a transceiver module (i.e., transceiver), a counter module (i.e., counter), a processing module (i.e., processor), and/or a clock module (i.e., clock) or timer module (i.e., timer). One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

As used herein, the term “processor” can include general purpose processors, specialized processors such as central processing units (CPUs), graphics processing units (GPUs), digital signal processors (DSPs), microcontrollers (MCUs), embedded controller (ECs), field programmable gate arrays (FPGAs), or other types of specialized processors, as well as base band processors used in transceivers to send, receive, and process wireless communications.

### EXAMPLE EMBODIMENTS

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Aspects of the present technology are directed toward enabling metadata for media content to be sent from a processing unit to a display controller (e.g., also known as a timing controller (TCON)) associated with an embedded display. Some systems are unable to properly display high dynamic range (HDR) content because of limitations of both the hardware of the processing unit and/or the display interface. For example, for certain embedded systems, metadata describing the luminance and color values of visual content is required by the display controller to properly scale the luminance and tone map the color of the content based on the capabilities of the display. At least some implementations of the embedded DisplayPort (eDP) standard are unable to send this metadata over the main channel of the eDP interface.

The present technology allows metadata to be sent over a sideband channel of the eDP interface (an auxiliary message sideband channel) from the processing unit to the display controller. In this way, the color and luminance metadata values for given media content may be used by the display controller to tone map the color and luminance of video content based on the capabilities of the embedded display.

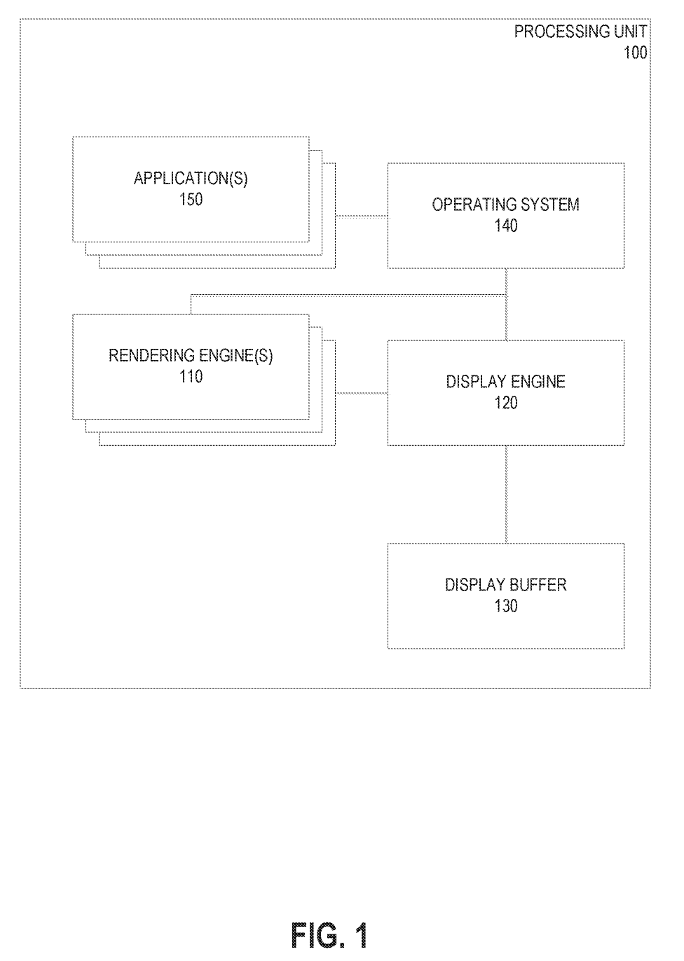

FIG. 1 illustrates a processing unit 100 in accordance with an example embodiment. The processing unit 100 can be a Central Processing Unit (CPU), Graphics Processing Unit (GPU), or other similar processing unit. In some aspects, the processing unit 100 can include one or more rendering engines 110, one or more display engines 120, one or more display buffers 130 and a number of other functional modules. The other functional modules of the processing unit 100 are not necessary for an understanding of aspects of the present technology, and therefore will not be described further herein, as they will be readily recognized by those of ordinary skill in the relevant art.

The processing unit 100 can be configured to execute instructions stored in the readable media of the one or more computing device to implement an Operating System (OS) 140 and one or more other applications 150. The one or more other applications 150 are not necessary for an understanding of aspects of the present technology, and therefore will not be described further herein. The OS 140 can be configured to control the execution of the one or more other applications 150, and control the functions performed by the one or more rendering engines 110, the one or more display engines 120 and the one or more display buffers 130.

Upon system boot up, the operation system 140 can instruct the display engine 120 to determine what capabilities an associated display (not pictured) possesses. For example, the OS 140 may determine whether an associated display is HDR capable. An HDR capable display can display HDR content, either in its original form, or adjusted appropriately to the capabilities of the display. In some examples, these capabilities are stored for later reference.

When visual content (e.g., video or image content) is to be displayed, the operating system 140 or an application 150 may send data describing or otherwise representing the visual content to the rendering engine 110 or the display engine 120. In some examples, this data is accessed from an associated storage device or downloaded over a network. In some examples, the rendering engine 110 uses model data (e.g., a 2D or 3D model) to generate a visual image or series of visual images. The visual image data is then forwarded to the display engine 120.

In some examples, the display engine 120 uses data provided by the rendering engine 110 or the operating system 140 to create a series of frames, each frame representing a single image in visual content. In other examples the display engine generates a static image for a visual interface for an application.

In some examples, the visual content is a video presentation with a fixed frame rate (e.g., a 24 frame per second video). In other examples, the frame rate is based on how quickly the rendering engine 110 can generate the visual content. For example, in interactive visual media, such as a video game, the complexity of the visual data may vary and thus the time needed to render frames may change. This may result in a variable frame rate.

In some examples, the display engine 120 inserts data for each frame into the display buffer 130. In some examples, the data in the display buffer 130 represents a color or value for each pixel of an associated display. In some examples, the data in the display buffer 130 may be a bitmap for each frame. In some examples, the display engine 120 may determine whether a given frame has associated metadata. In other example embodiments, other components such as the OS 140 may make this determination. In this example, the associated metadata is data about the luminance and color of one or more frames.

In some examples, a given piece of video content can have a single maximum luminance value and a single color range value for the entire piece of video content (e.g., one set of values for a whole movie.) In other examples, a piece of video content can have multiple sets of metadata that are paired with particular groups of frames (e.g., particular scenes in a movie). When the display engine 120 determines that a frame or group of frames has associated metadata, the display engine 120 transmits that metadata to the appropriate display.

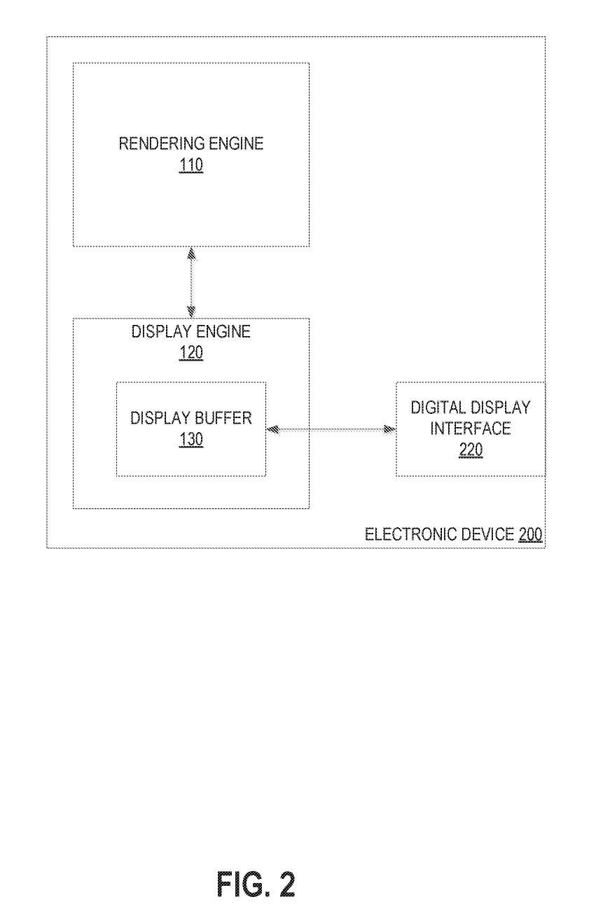

FIG. 2 illustrates an example electronic device in accordance with an example embodiment. The electronic device 200 may be a Central Processing Unit (CPU), Graphics Processing Unit (GPU), a circuit board including a CPU or a GPU, and so on. In some examples, the electronic device 200 can include a rendering engine 110, a display engine 120, and a digital display interface 220.

As noted above in the discussion of FIG. 1, the rendering engine 110 can use model data (e.g., a 2D or 3D model) to generate a visual image. If data does not need to be rendered, the display engine 120 may receive the visual data from another source (e.g., an application, the OS, or from a storage resource).

In some examples, the display engine 120 receives image data from the rendering engine 110 or other source (e.g., in storage) and uses it to create a series of frame images. Each frame is created by the display engine and placed sequentially in the display buffer 130. In some examples, the display buffer 130 can be a portion of memory that receives a bitmap from the display engine 120 that represents a single image or frame. In other example embodiments, the display buffer 130 can be large enough to store additional frames.

In some examples, the display engine 120 or display buffer 130 can use a digital display interface 220 to transmit the contents of the display buffer 130 to a display panel for presentation. Examples of digital display interfaces include DisplayPort, embedded DisplayPort (eDP), video graphics array (VGA), digital visual interface (DVI), and high-definition multimedia interface (HDMI). Each digital display interface includes different features and capabilities.

In one example, the digital display interface 220 can be an eDP interface. The eDP interface standard includes at least a main channel and an auxiliary sideband channel. In some examples, the main channel is configured to send frame data from the display buffer 130 and a certain number of secondary data packets (SDP). However, the number of SDP's is insufficient to transmit metadata associated with video content to a display device. In some examples, in order to transmit metadata, the digital display interface 220 uses the sideband channel of the interface. In some examples, the metadata is transmitted as part of a “flip call.”

A flip call occurs when the display buffer 130 has been updated with new data. In some examples, the display buffer 130 includes a plurality of different layers or frames stored in the display buffer 130 at once. For example, the display buffer 130 may include frame data for several different applications, for the OS, and for the mouse pointer. In some examples, when at least one of these layers or frames is changed, the processing unit (e.g., unit 100 in FIG. 1) or the display engine 120 transmits a flip call to a display controller associated with a display device.

In this example, the flip call is transmitted over a sideband messaging channel of the digital display interface 220. When metadata is identified for a particular frame or set of frames or the metadata is changed, the metadata information can be included in the flip call that is sent when the display buffer 130 data is updated. In other example embodiments, the metadata may be sent without being included in a flip call.

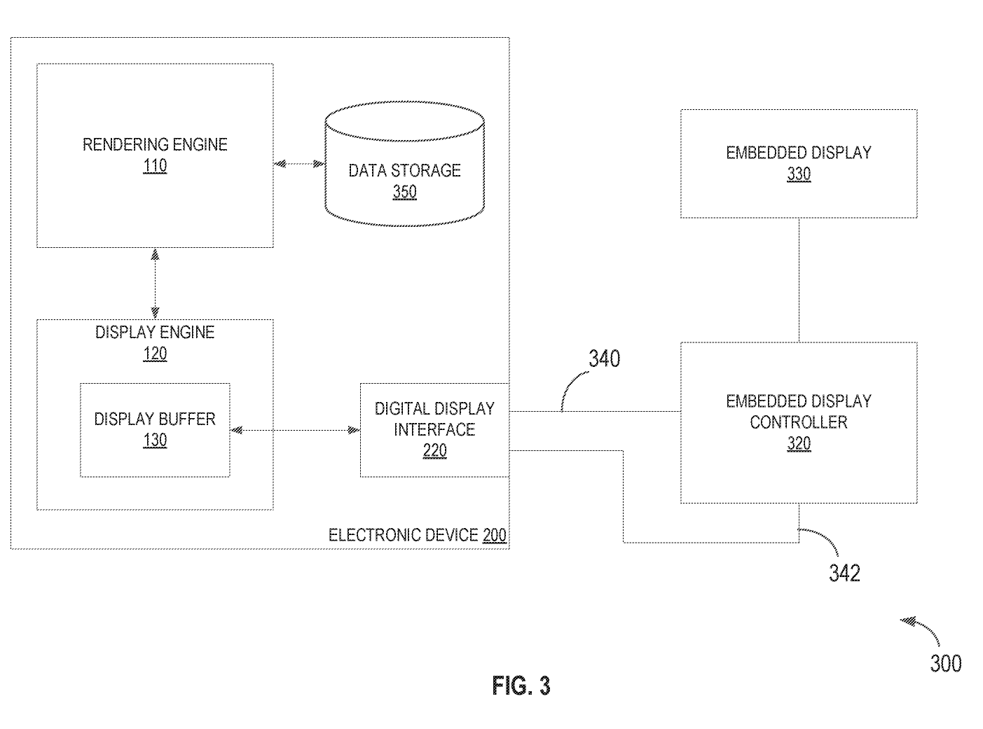

FIG. 3 illustrates a computer system 300 in accordance with an example embodiment. The computer system 300 may be a laptop, a tablet computer, an all-in-one computer, or other computer system with an embedded display 330. In some examples, the computer system 300 includes an electronic device 200, an embedded display controller 320, an embedded display 330, and a data storage resource 350.

As noted above in the discussion of FIG. 2, the electronic device 200 includes a rendering engine 110, a display engine 120, a display buffer 130, and a digital display interface 220. As above, the rendering engine 110 may create visual data from model data for use by the display engine 120. The display engine 120 may use provided visual data to generate one or more frames. Those frames (e.g., a bitmap for the image to be displayed) are inserted into the display buffer 130.

In some examples, the contents of the display buffer 130 are transmitted by a digital display interface 220 to an embedded display controller 320. In this example, the digital display interface 220 is an embedded DisplayPort interface (eDP). In some examples, the digital display interface 220 converts the information in the digital buffer 130 into digital information packets that are sent over the main channel 340 of the digital display interface 220.

In this specific example, the digital display interface 220 is constructed such that metadata associated with the video frame is unable to be transmitted over the main channel 342 of the digital display interface 220. Specifically, the digital display interface 220 is an integrated circuit that allows certain information to be transmitted over the main channel 340. This includes circuitry that is able to transmit frame data (e.g., data stored in the display buffer 130) that instructs the embedded display controller 320 what to display on the embedded display 330. In this example, the digital display interface 220 also includes circuitry that can send secondary data packets of certain types over the main channel 340.

Because the eDP standard was created before the needed for HDR metadata arose, some implementations of the eDP standard do not have the circuitry necessary to create SDPs that can relay the HDR metadata over the main channel 340. In order to convey the HDR (or other) metadata to the embedded display controller 320, another channel of the digital display interface can be used. In this example, an auxiliary sideband channel 342 of the digital display interface 220 can be used to transmit associated metadata to the embedded display controller 320. As noted above, the metadata may be included in a flip call sent over the auxiliary sideband channel 342.

In some examples, the embedded display controller 320 receives frame data from the display buffer 120 via the main channel 340 of the digital display interface 220. In some examples, the embedded display controller 320 also receives metadata associated with the frame data from the auxiliary sideband channel 342 of the digital display interface.

In some examples, the embedded display controller 320 may adjust the frame data based on the received metadata and the display characteristics of the embedded display 330. For example, in some cases the metadata includes a maximum luminance value of 4000 nits and the embedded display 330 is able to show a range of up to 2000 nites. In response the embedded display controller 320 may scale the luminance values in the frame data such that the visual content is shown within the capabilities of the embedded display with minimal loss of detail or contrast. This may include simple solutions such as adjusting the luminance values in a video or image or more complex algorithms to scale down maximum luminance but also retain as much detail as possible.

In other examples, the associated metadata can include the color range value for the one or more frames. The embedded display controller may tone map the frame data based on the color capabilities of the embedded display and the color range value for the one or more frames.

In some examples, once the embedded display controller has adjusted the frame data based on the associated metadata, the frame data is then displayed on the embedded panel. In some examples, the embedded panel can be one of a light-emitting diode display (LED), an electroluminescent display (ELD), an electronic paper or display, a plasma display panel (PDP), a liquid crystal display (LCD), a high-performance addressing display (HPA), a thin-film transistor display (TFT), an organic light-emitting diode display (OLED), a digital light processing display (DLP), a surface-conduction electron-emitter display (SED), a field emission display (FED), a laser TV display. A carbon nanotube display, a quantum dot display, an interferometric modulator display (IMOD), or a digital microshutter display (DMS).

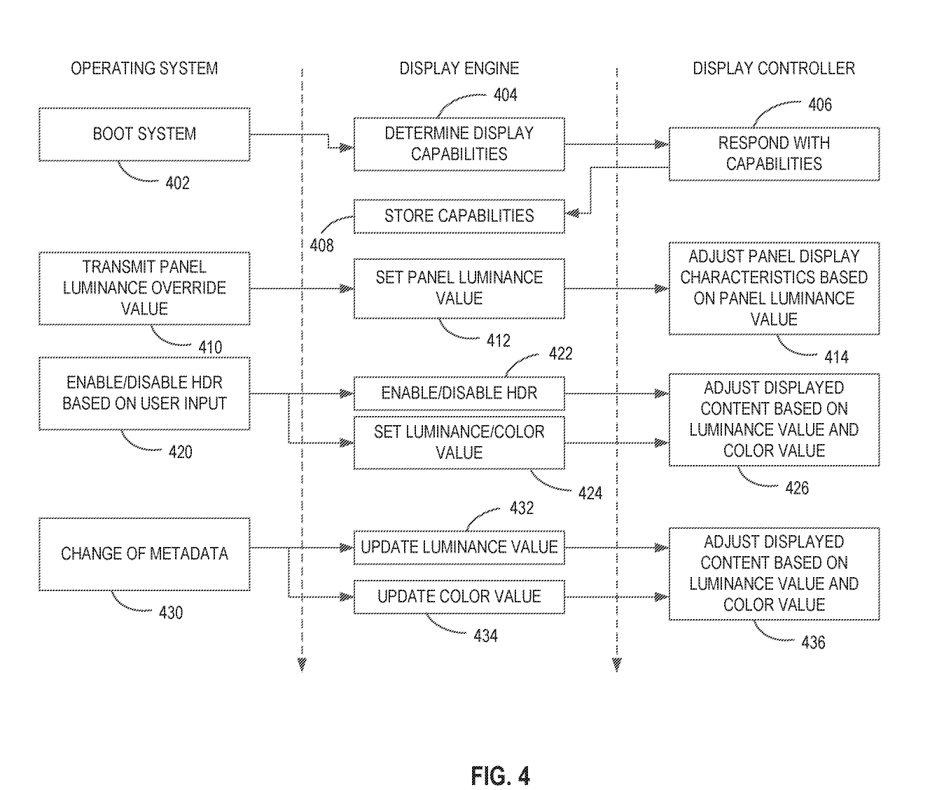

FIG. 4 is a block diagram illustrating a method for enabling an HDR capable display in accordance with some example embodiments. In this example, when the system boots up the operating system (e.g., OS 140 in FIG. 1) queries the display engine to determine if the associated embedded display panel (e.g., embedded display 330 in FIG. 3) is high dynamic range (HDR) capable. An HDR capable display is able to switch into HDR mode, which allows a greater range of luminance values and color values to be represented.

In some examples, this query is part of the Integrated Display Descriptor (IDD) call for the eDP interface. The display engine sends (404) the query to the display controller (also known as a timing controller or TCON). In response, the display controller responds (406) with a list of the capabilities of the display.

In some examples, the response can be formatted as shown in Table 1.

TABLE 1

| Definition: | Description |
|---|---|
| DPCD_INTEL_EDPHDR_CAPS | Report TCON capabilities |
| [RO] 4 Bytes | Byte 0: Interface version (=01 h) |
| | Byte 1: TCON capability |
| | Bit 0: Supports 2084 decode |
| | Bit 1: Supports 2020 gamut |
| | Bit 2: Supports panel tone mapping |
| | Bit 3: Supports segmented backlight |
| | Bit 4: Supports Brightness controls in nits |
| | level using AUX |
| | Bit 5: Supports brightness optimization |

In the above table, the display controller uses Byte 1 to determine whether the display controller is HDR capable. Each bit in the above listed Byte 1 is associated with a particular capability. Bit0 is a Boolean value (i.e. a value that is either true or false) that represents whether the display controller is able to perform decoding of image data that is formatted using the electro-optical transfer function (EOTF) 2084 format. The EOTF 2084 data format defines a lookup table of 10-bit values from 0-1023 that reflect absolute luminance values from 0 to 10,000 Cd/m̂2 (e.g., nits).

Bit1 is a Boolean value that represents whether the display controller is able to receive and understand data in the BT. 2020 color format. BT.2020 color format BT uses up to 12-bit values to represent color depth and thus can represent a very large range of different colors (e.g., up to 68 billion colors).

Bit2 is a Boolean value that represents whether the display controller supports a tone-mapping function. In this context, tone-mapping can refer to scaling down luminance values to within the range of a display panel so that the detail is not all lost. For example, if a given display panel's maximum luminance is 1000 nits and given image or video had a section in which all values were above the 1000 nits, tone-mapping can allow the values to be scaled down to preserve some or all detail. Without tone-mapping, all the values would simply be represented as uniformly at the maximum, without any different between a value that was 5000 nits and one that was 1001 nits.

Bit3 is a Boolean value representing whether the display panel uses a segmented backlight design. Bit4 is a Boolean value representing whether the display controller supports using brightness control using the sideband channel interface. Bit5 is a Boolean value representing whether the display controller supports the new brightness optimization algorithms being deployed in future OS versions.

In some examples, several of the listed capabilities are associated with HDR capability including, but not necessarily limited to bit0, which is the capability to perform 2084 decode, and Bit2, which is the capability to perform panel tone mapping. In some examples, a display controller that is capable of performing 2084 decode and panel tone mapping can be denoted as HDR capable. As seen above, the other bits of byte are associated with other capabilities, such as Bit1 (which is associated with 2020 gamut) and Bit 3 which is associated with a segmented backlight. The display controller may store (408) the reported display controller capabilities for later reference.

In some examples, once the OS has determined that the display controller is HDR capable, the OS may optionally change the panel luminance values. This allows a much more precise control of luminance instead of using generic precision limited percentage values. To do so, the OS sends (410) a panel luminance override value to the display engine. The display engine then sets (412) the panel luminance value. In some examples, the display engine can use a sideband message channel to communicate from the display engine to the display controller.

In some examples, the override values are transmitted through a command that is formatted as in Table 2:

TABLE 2

| Definition: | Description |
|---|---|
| DPCD_INTEL_EDPHDR_PANEL | Override of panel luminance from source |
| LUMINANCE_OVERRIDE | side. This won't be presided by panels |
| | between panel power cycles. The display |
| | controller can use this in case of display |
| | controller based tone mapping. Range 0- |
| | 2¹⁶-1 |
| [RO] 8 Bytes | Bytes 0-1: Min luminance |
| | Byte 2-3: Max luminance |
| | Bytes 4-5: Max full frame luminance |
| | Bytes: 6-7: Reserved |

Furthermore, once the OS has determined that the display controller is HDR capability, the OS makes a toggle option to enable or disable HDR available (420) to the user. Once a user toggles HDR to “On”, the OS requests the display controller to switch mode from SDR to HDR by requesting the display engine to set the HDR mode to “On” 422 and start passing metadata (luminance value and color value) 424 to the display controller. With HDR mode on, the display engine can send colors in the enhance color range of HDR. Specifically, HDR enables a 10 bit color descriptor that can use an RGB10-bit buffer to enable the enhanced HDR color range.

In some examples, these commands are formatted as in Table 3:

TABLE 3

| Definition: | Description |
|---|---|
| DPCD_INTEL_EDPHDR_GET | Byte 0: |
| SET_CTRL_PARAMS | |
| [RO] 2 Bytes | Bit 0: Decode with 2084 (default is 0) |
| | Bit 1: 2020 color gamut |
| | Bit 2: Enable tone mapping in display controller |
| | Bit 3: Enable segmented backlight if available |
| | Bit 4: Enable AUX based brightness control |
| | Byte 1: reserved |

When the user plays HDR content video, the OS sends content metadata of luminance values in the flip call. The display engine sends metadata to the displaying controller through the sideband channel of the digital display interface and additionally enables tone mapping at the embedded display controller.

In some examples, these metadata can be formatted as follows in Table 4:

TABLE 4

| Definition: | Description |
|---|---|
| DPCD_INTEL_EDPHDR_CONTENT | Byte 0-1: Max content light level |
| LUMINANCE | |
| [RO] 2 Bytes | Bytes 2-3 Max frame average light level |

The embedded display controller uses metadata information to decode incoming HDR video content and tone map the content to panel's luminance and color range 426 if tone mapping is enabled at the embedded display controller by the display engine.

When content metadata changes, the OS sends updated content metadata of luminance values in flip call as discussed above and the display engine sends 432 and 434 updated metadata to the display controller for content decode. In response, the display controller adjusts 436 the displayed content based on the luminance value and color value.

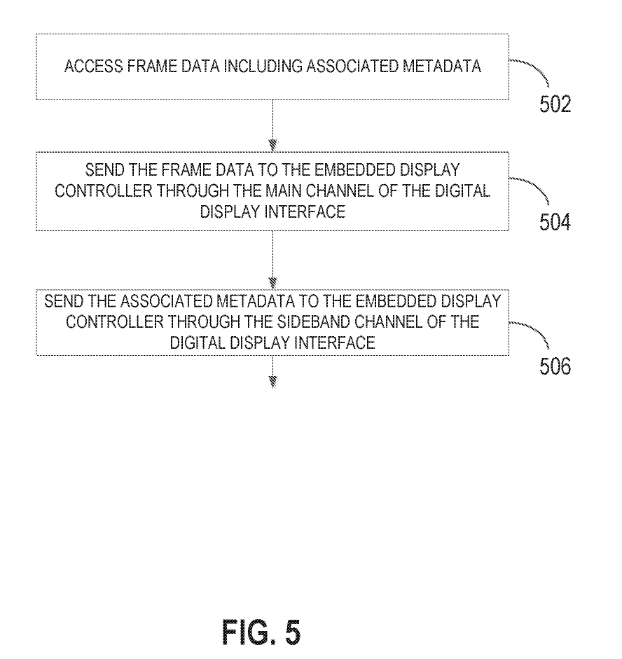

FIG. 5 is a flow diagram for a method of providing HDR metadata over an eDP interface in accordance with some example embodiments. In some examples, a graphics processing unit (e.g., a GPU) accesses (502) frame data and associated metadata. In some examples, the frame data and associated metadata are stored in a storage device associated with the computer system.

In some examples, the eDP interface is integrated into a computer system.

In some examples, the computer system is a laptop computer. In other example embodiments, the computer system is a tablet computer. In other example embodiments, the computer system may be an all-in-one computer or any other system with an embedded display panel.

The graphics processing unit sends (504) send the frame data to the embedded display device through a main channel of the digital display interface. As noted above, the main channel of the digital interface is configured to transfer frame data and certain secondary data packets. However, the circuitry of the digital display interface is structured such that it is not possible to transfer HDR metadata over the main channel. In some examples, the main channel of the digital display interface uses a synchronous transfer protocol.

In some examples, the graphics processing unit sends (506) the associated metadata to the embedded display device through a sideband channel of the digital display interface. This auxiliary sideband channel is able to relay the metadata to the embedded display controller. In some examples, the associated metadata sent using an asynchronous transfer protocol.

In some examples, the associated metadata includes luminance and color value information for one or more frames. The associated metadata may include a maximum luminance value for the one or more frames. The associated metadata may include the color range value for the one or more frames.

In some examples, an embedded display controller, connected to the graphics processing unit, adjusts the frame data based on the associated metadata. In some examples, adjusting the frame data based on the associated metadata includes scaling the luminance of the frame data based on the maximum luminance capability of the embedded display and the maximum luminance value for the one or more frames. In some examples, adjusting the frame data based on the associated metadata includes tone mapping the frame data based on the color capabilities of the embedded display and the color range value for the one or more frames.

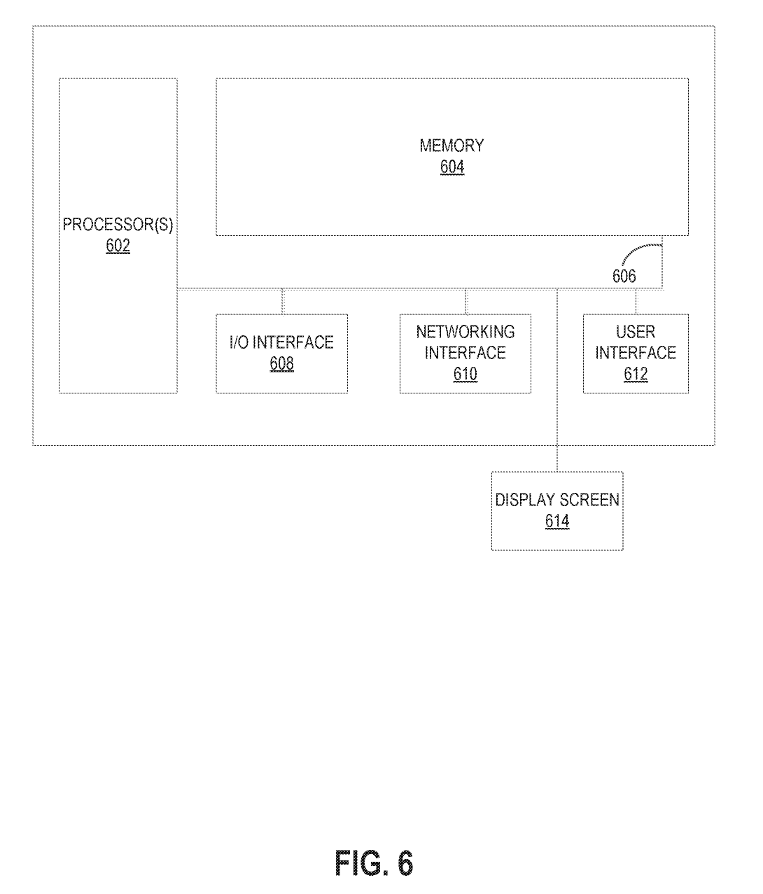

FIG. 6 depicts an exemplary system upon which embodiments of the present disclosure may be implemented. For example, the system of FIG. 6 may be a computer system with an embedded panel display that is used to display visual content. Components of the system of FIG. 6 may be used for presenting visual content. For example, the processing unit 100 of FIG. 1 may be the same as processor(s) 602. The device or system can include a memory controller, a memory 604, and circuitry 606. Generically speaking, various embodiments of such devices or systems as shown in FIG. 6 can include smart phones, laptop computers, handheld and tablet devices, CPU systems, SoC systems, server systems, networking systems, storage systems, high capacity memory systems, or any other computational system. In one embodiment, such devices or systems can include an embedded display, for example smart phones, laptop computers, tablet devices, all-in-one computers, etc.

In some embodiments, devices or system can also include an I/O (input/output) interface(s) 608 for controlling the I/O functions of the device or system, as well as for I/O connectivity to devices outside of the system. A network interface 610 can also be included for network connectivity, either as a separate interface or as part of the I/O interface 608. The network interface can control network communications both within the system and outside of the system. The network interface can include a wired interface, a wireless interface, a Bluetooth interface, optical interface, and the like, including appropriate combinations thereof. Furthermore, the system can additionally include various user interfaces 612, display panels or screens 614, as well as various other components that would be beneficial for such a device or system.

The disclosed embodiments may be implemented, in some cases, in hardware, firmware, software, or any combination thereof. Portions of the disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

### EXAMPLES

The following examples pertain to specific example embodiments and point out specific features, elements, or steps that can be used or otherwise combined in achieving such embodiments.

In one example, there is provided a processing unit comprising a display engine, configured to access frame data and associated metadata; and send the associated metadata on a channel that is different than a channel configured to send the frame data.

In one example of a processing unit the associated metadata is sent using a sideband channel of a digital display interface and the frame data is sent using a main channel of the digital display interface.

In one example of a processing unit the digital display interface is an embedded display port interface.

In one example of a processing unit the frame data is sent using a synchronous transfer protocol.

In one example of a processing unit the associated metadata is sent using an asynchronous transfer protocol.

In one example of a processing unit the main channel of the digital display interface structure prevents (or otherwise does not enable) transmission of the associated metadata.

In one example of a processing unit the associated metadata includes luminance and color information for one or more frames.

In one example of a processing unit the associated metadata includes a maximum luminance value for one or more frames.

In one example of a processing unit the associated metadata includes a color range value for one or more frames.

In one example, there is provided an electronic device comprising a digital display interface, configured to connect to an embedded display device, the digital display interface including a main channel and a sideband channel; and a display engine, configured to: access frame data and associated metadata, send the frame data to the embedded display device through the main channel of the digital display interface, and send the associated metadata to the embedded display device through the sideband channel of the digital display interface.

In one example of an electronic device the digital display interface is an embedded display port interface.

In one example of an electronic device the frame data is sent using a synchronous transfer protocol.

In one example of an electronic device the associated metadata sent using an asynchronous transfer protocol.

In one example of an electronic device the main channel of the digital display interface structure prevents (or otherwise does not enable) transmission of the associated metadata.

In one example of an electronic device the associated metadata includes luminance and color value information for one or more frames.

In one example of an electronic device the associated metadata includes a maximum luminance value for the one or more frames.

In one example of an electronic device the associated metadata includes a color range value for the one or more frames.

In one example of an electronic device the device further includes an embedded display device.

In one example of an electronic device the device further includes display controller connected to the display engine and the embedded display device.

In one example of an electronic device the electronic device is a laptop.

In one example of an electronic device the electronic device is a tablet computer.

In one example of an electronic device the electronic device is an all-in-one computer.

In one example of a computer system, the computer system comprises

one or more processors, a digital display interface, a graphics processing unit, configured to access frame data and associated metadata, send the frame data to the embedded display device through a main channel of the digital display interface, and send the associated metadata to the embedded display device through a sideband channel of the digital display interface an embedded display controller, connected to the graphics processing unit and configured to: adjust the frame data based on the associated metadata, and send the frame data to an embedded display for presentation.

In one example of a computer system the main channel of the digital display interface uses a synchronous transfer protocol.

In one example of a computer system the frame data is sent using a synchronous transfer protocol.

In one example of a computer system the associated metadata sent using an asynchronous transfer protocol.

In one example of a computer system the main channel of the digital display interface structure prevents (or otherwise does not enable) transmission of the associated metadata.

In one example of a computer system the associated metadata includes luminance and color value information for one or more frames.

In one example of a computer system the associated metadata includes a maximum luminance value for the one or more frames.

In one example of a computer system adjusting the frame data based on the associated metadata includes scaling the luminance of the frame data based on the maximum luminance capability of the embedded display and the maximum luminance value for the one or more frames.

In one example of a computer system the associated metadata includes a color range value for the one or more frames.

In one example of a computer system adjusting the frame data based on the associated metadata includes tone mapping the frame data based on the color capabilities of the embedded display and the color range value for the one or more frames.

In one example of a computer system the computer system further comprises a cable connecting the graphic processing unit to the embedded display controller wherein the main channel and sideband channel use the cable to communicate with the embedded display controller.

In one example of a computer system the computer system is a laptop computer.

In one example of a computer system the computer system is a tablet computer.

In one example, there is provided a method comprising accessing, frame data and associated metadata, and sending the associated metadata from a processing unit to a display controller on a channel that is different than a channel configured to send the frame data.

In one example the associated metadata is sent using a sideband channel of a digital display interface and the frame data is sent using a main channel of the digital display interface.

In one example the digital display interface is an embedded display port interface.

In one example the frame data is sent using a synchronous transfer protocol.

In one example the associated metadata is sent using an asynchronous transfer protocol.

In one example the main channel of the digital display interface structure prevents (or otherwise does not enable) transmission of the associated metadata.

In one example the associated metadata includes luminance and color information for one or more frames.

In one example the associated metadata includes a maximum luminance value for one or more frames.

In one example the associated metadata includes a color range value for one or more frames.

In one example, there is provided a non-transitory computer-readable storage medium storing instructions that, when executed by the one or more processors of a machine, cause the machine to perform operations comprising accessing, frame data and associated metadata, and sending the associated metadata from a processing unit to a display controller on a channel that is different than a channel configured to send the frame data.

In one example of a non-transitory computer-readable storage medium the digital display interface is an embedded display port interface.

In one example of a non-transitory computer-readable storage medium the frame data is sent using a synchronous transfer protocol.

In one example of a non-transitory computer-readable storage medium the associated metadata is sent using an asynchronous transfer protocol.

In one example of a non-transitory computer-readable storage medium the main channel of the digital display interface structure prevents (or otherwise does not enable) transmission of the associated metadata.

In one example of a non-transitory computer-readable storage medium the associated metadata includes luminance and color information for one or more frames.

In one example of a non-transitory computer-readable storage medium the associated metadata includes a maximum luminance value for one or more frames.

In one example of a non-transitory computer-readable storage medium the associated metadata includes a color range value for one or more frames.

While the forgoing examples are illustrative of the principles of the present technology in one or more particular applications, it will be apparent to those of ordinary skill in the art that numerous modifications in form, usage and details of implementation can be made without the exercise of inventive faculty, and without departing from the principles and concepts of the technology.

What is claimed is:

1. A processing unit comprising:
a display engine, configured to:
access frame data and associated metadata; and
send the associated metadata on a channel that is different than a channel configured to send the frame data.

2. The processing unit of claim 1, wherein the associated metadata is sent using a sideband channel of a digital display interface and the frame data is sent using a main channel of the digital display interface.

3. The processing unit of claim 2, wherein the digital display interface is an embedded display port interface.

4. The processing unit of claim 1, wherein the frame data is sent using a synchronous transfer protocol.

5. The processing unit of claim 1, wherein the associated metadata is sent using an asynchronous transfer protocol.

6. The processing unit of claim 2, wherein the main channel of the digital display interface structure prevents transmission of the associated metadata.

7. The processing unit of claim 1, wherein the associated metadata includes luminance and color information for one or more frames.

8. The processing unit of claim 7, wherein the associated metadata includes a maximum luminance value for one or more frames.

9. The processing unit of claim 1, wherein the associated metadata includes a color range value for one or more frames.

10. An electronic device, comprising:
a digital display interface, configured to connect to an embedded display device, the digital display interface including a main channel and a sideband channel; and
a display engine, configured to:
access frame data and associated metadata;
send the frame data to the embedded display device through the main channel of the digital display interface; and
send the associated metadata to the embedded display device through the sideband channel of the digital display interface.

11. The electronic device of claim 10, wherein the digital display interface is an embedded display port interface.

12. The electronic device of claim 10, wherein the frame data is sent using a synchronous transfer protocol.

13. The electronic device of claim 10, wherein the associated metadata sent using an asynchronous transfer protocol.

14. The electronic device of claim 10, wherein the main channel of the digital display interface structure prevents transmission of the associated metadata.

15. The electronic device of claim 10, wherein the associated metadata includes luminance and color value information for one or more frames.

16. The electronic device of claim 15, wherein the associated metadata includes a maximum luminance value for the one or more frames.

17. The electronic device of claim 15, wherein the associated metadata includes a color range value for the one or more frames.

18. The electronic device of claim 10, wherein the device further includes an embedded display.

19. The electronic device of claim 10, wherein the device further includes a display controller connected to the display engine and the embedded display.

20. A computer system comprising:
one or more processors;
a digital display interface;
a graphics processing unit, configured to:
access frame data and associated metadata;
send the frame data to the embedded display device through a main channel of the digital display interface; and
send the associated metadata to the embedded display device through a sideband channel of the digital display interface
an embedded display controller, connected to the graphics processing unit and configured to:
adjust the frame data based on the associated metadata; and
send the frame data to an embedded display for presentation.

21. The computer system of claim 20, wherein the main channel of the digital display interface structure prevents transmission of the associated metadata.

22. The computer system of claim 20, wherein the associated metadata includes luminance and color value information for one or more frames.

23. The computer system of claim 20, wherein the associated metadata includes a maximum luminance value for the one or more frames.

24. The computer system of claim 20, wherein the associated metadata includes a color range value for the one or more frames.

25. The computer system of claim 20, further comprising:
a cable connecting the graphic processing unit to the embedded display controller wherein the main channel and sideband channel use the cable to communicate with the embedded display controller.
